(19) United States
(12) Patent Application Publication
(10) Pub. No.: US 2021/0364629 A1
(43) Pub. Date: Nov. 25, 2021

(54) IMPROVEMENTS IN OR RELATING TO THREAT CLASSIFICATION

(71) Applicant: Radio Physics Solutions Limited, Herefordshire (GB)

(72) Inventors: Philip Edward RYDER, Herefordshire (GB); David LEONARD, Birmingham (GB); Tony TSZ-HONG YAU, Birmingham (GB); Srikrishna NUDURUMATI, Birmingham (GB)

(21) Appl. No.: 17/054,407

(22) PCT Filed: May 10, 2019
(86) PCT No.: PCT/GB2019/051285

§ 371 Date: Nov. 10, 2020

(30) Foreign Application Priority Data
May 10, 2018 (GB) 1807616.6
Jun. 21, 2018 (CN) 201810643110.8

(51) Int. Cl. G01S 13/88; G01S 13/86; G01S 13/66; G01S 7/41; G01S 13/04

(52) U.S. Cl. CPC G01S 13/887; G01S 13/867; G01S 13/04; G01S 7/411; G01S 13/66

(57) ABSTRACT

A system (100) for remote detection of one or more dimensions of a metallic and/or dielectric object (116), comprising: at least one sensor component configured to identify one or more candidate objects (111), a transmission apparatus, including a transmission element (106), configured to direct microwave and/or mm wave radiation, a detection apparatus (108,109) configured to receive radiation from an entity resulting from the transmitted radiation and to generate one or more detection signals in the frequency domain, and a controller (104), the controller being operable to: generate location data for the one or more candidate objects (111) based on data received from the sensor component; cause the transmission apparatus to direct radiation towards a candidate object, cause the transmitted radiation to be continuously swept over a predetermined range of frequencies, perform a transform operation on the detection signals to generate one or more transformed signals, and determine, from one or more features of the transformed signal, one or more characteristics of the candidate object upon which the transmitted radiation is incident.

The present invention relates to the detection of objects, and more particularly, to techniques for remote detection and measurement of objects.

It is well known to use electromagnetic radiation to detect the presence of objects (e.g. handheld detectors used for detecting objects on or under the ground, and walk-through arches at airports).

However, the conventional detectors used at airports may be unable to determine the dimensions of objects to any significant degree, and thus may be unable to distinguish between objects of different types, i.e. harmless (belt buckles, cameras), and potentially dangerous (guns, knives).

The detection of concealed weapons, especially handguns, may be a very great problem for security applications that currently cannot be policed without a non-portable system, for example random checks in an urban environment. The use of microwaves (electromagnetic waves with wavelengths in the centimeter to millimeter range) may provide a means for the standoff detection and identification of concealed conducting items such as handguns and knives. Large metal objects, such as handguns, may give a significantly different and generally larger response when irradiated by low power microwaves than that from the human body, clothing and/or benign normally-carried objects. The larger response may be detected using a combination of antenna and sensitive receiver.

By actively illuminating an object with wide-range swept and/or stepped frequency microwave and/or millimeter wave radiation, the frequency response of the return signal may give the range and/or information regarding dimensions of the object. This method may be substantially equivalent to using a fast microwave pulse and measuring the response as function of time, as used in conventional RADAR. Selecting a part of the return signal within a particular range may aid the positive identification of the suspect object and may also help to reject background signals. The analysis of the time response may give further information as to the dimensions of the target. This technique may also be applied to the detection of dielectric layers, such as, for example, an explosive vest strapped to a suicide bomber (see Active millimeter wave detection of concealed layers of dielectric material, Bowring N. J., Baker J. G., Rezgui N., Southgate M., Proceedings of the SPIE 6540-52 2007; and A sensor for the detection and measurement of thin dielectric layers using reflection of frequency scanned millimetric waves, Bowring N. J., Baker J. G., Rezgui N., Alder J. F. Meas. Set Technol 19 024004 (7 pp) 2008). However, such techniques have not been heretofore used for detecting and measuring metal objects.

A system based on swept frequency RADAR has been proposed (U.S. Pat. Nos. 6,359,582, 6,856,271 and 7,450,052). In the disclosed systems, the frequency may be swept by typically by 1 GHz around about 6 GHz. The depth resolution that is achievable is therefore only 15 cm, thus the system may not give details of the objects. The detection relies on comparing gross features of the signal as a whole with similar suspicious and benign signals to which the system had been previously exposed. Also the measurement of polarization properties of the scattered signal may be used.

In the aforementioned patents, the low frequency of operation makes the angular resolution of the antennae poor and the wide field of view makes it difficult to single out particular targets and/or to determine on which part of the target the threat is situated. This may be improved by changing to higher frequencies where microwave optics becomes effective. This may be particularly important for explosives detection where the contrast from the body signal is low. Systems working at higher frequencies but still with a limited bandwidth have been proposed by Gorman et al (U.S. Pat. No. 6,967,612) and by Millitech (U.S. Pat. No. 5,227,800). Many systems have been produced to enable images of the target to be obtained using either active microwave illumination or the passive thermal emission of the target (SPIE 2007). These systems use multi-detector arrays and some form of mechanical scanning. Passive systems, though giving more realistic images, tend to be slow and show poor contrast for dielectric targets. Active illumination systems can be acquired faster, but may suffer from strong reflections from benign objects such as the human body, which make it difficult to distinguish from metal threat objects. All scanning systems may require complex human or Artificial Intelligence interaction to interpret the image and/or to pick out the suspect features. This makes their deployment in many applications difficult.

It is apparent that systems which can identify threat objects at standoff distances may have many applications, where conventional metal detector booths are inappropriate. These may include covert surveillance and mobile operation in streets and buildings.

WO2009115818 aimed to address this need by the provision of a system for remote detection of one or more dimensions of a metallic and/or dielectric object. The system comprises a transmission apparatus, a detection apparatus and a controller. The transmission apparatus, includes a transmission element, and is configured to direct microwave and/or mm wave radiation in a predetermined direction. The detection apparatus is configured to receive radiation from an entity resulting from the transmitted radiation and to generate one or more detection signals in the frequency domain. The controller is operable to guide the following three operational steps: (i) cause the transmitted radiation to be swept over a predetermined range of frequencies, (ii) perform a transform operation on the detection signal(s) to generate one or more transformed signals in the time domain, and (iii) determine, from one or more features of the transformed signal, one or more dimensions of a metallic or dielectric object upon which the transmitted radiation is incident.

This system described in WO2009115818 addressed the broad issues of covert surveillance and mobile operation in streets and buildings, but did not provide a complete solution.

It is against this background that the present invention has arisen.

According to the present invention there is provided a system for remote detection of one or more dimensions of a metallic and/or dielectric object, comprising: at least one sensor component configured to identify one or more candidate objects, a transmission apparatus, including a transmission element, configured to direct microwave and/or mm wave radiation, a detection apparatus configured to receive radiation from an entity resulting from the transmitted radiation and to generate one or more detection signals in the frequency domain, and a controller, the controller being operable to:

(i) generate location data for the one or more candidate objects based on data received from the sensor component;

(ii) cause the transmission apparatus to direct radiation towards a candidate object,

(iii) cause the transmitted radiation to be continuously swept over a predetermined range of frequencies,

(iv) perform a transform operation on the detection signal(s) to generate one or more transformed signals, and

(v) determine, from one or more features of the transformed signal, one or more characteristics of the candidate object upon which the transmitted radiation is incident.

By sweeping continuously over a predetermined range of frequencies by applying a moving filter and coordinating the operation of the transmission apparatus with a sensor component for identifying candidate objects, the present invention provides a step change in approach which is intended to overcome some of the short comings in previous systems.

The combination of threat detection using microwave and/or mm wave radiation with sensor data obtained from one or more sensor components, enables the system to identify and track individuals or objects (collectively referred to as candidate objects) whose sensed data suggests they have a statistical likelihood of carrying one or more objects of interest or threat objects. The transmission apparatus can therefore be directed to that individual or object and track the individual as they move through the environment with or without an associated separable object such as a bag, rucksack or similar. This provides a step change in approach from scanning the environment with the transmission apparatus to identify one or more candidate objects to using sensor data to analyse the environment and prioritise scanning using the transmission apparatus.

In this context the “candidate object” may be an individual, who may be carrying one or more concealed metallic and/or dielectric objects. Alternatively, or additionally, the candidate object may be an inanimate object such as a bag, which may be carried by an individual or may be placed in the environment without contact with the individual.

The step of determining one or more characteristics of the candidate object includes identifying the presence or absence of a metallic and/or dielectric object of interest. If the candidate object is identified as carrying no metallic and/or dielectric objects of interests, then they may be classified as low risk objects and not tracked further.

If the candidate object is identified to include a metallic and/or dielectric object, then one or more dimensions of that object will be identified during the determining step. This allows non-threatening metallic and/or dielectric objects to be identified and discounted from being classified as a threat, thus reducing “false positive” results from the system.

The system of the present invention may be further configured to determine, based on the determined characteristics, that the candidate object is an object of interest, and upon determining that the candidate object is an object of interest, the system may be configured to track the candidate object using the at least one sensor.

Generating location data may comprise generating an estimated position of the candidate object within a model of the scene viewed by the sensor which may be a video sensor. The environmental model may be a three dimensional model of a location of interest monitored by one or more sensor components. Generating such a model allows the position of an object identified as an object of interest to be tracked before and after classification. This is especially important in a crowded or chaotic environment because occlusions of objects of interest can be overcome by tracking the movement of the individual or object through the environment and then directing the microwave/mm-wave radiation at the object on a subsequent occasion, once the occlusion is resolved.

With objects of interest marked and tracked by the system, for example using a unique ID assigned to the object during identification, security system operators can quickly identify high risk individuals and items and assess whether they require action.

In some embodiments, the at least one sensor component comprises a video sensor. Furthermore, in some embodiments identifying and determining the characteristics of the candidate objects may be performed autonomously. For example, identification and classification of candidate objects may be carried out by deep learning algorithms or neural networks using proprietary threat/non-threat classification libraries.

Using deep learning video analytics to allow sensor components to identify, classify, and in some cases track candidate objects in combination with the microwave and/or mm radiation screening apparatus of the system of the present invention for the detection of threat objects can thus provide an automated, holistic approach to threat detection.

The controller may be further configured to determine a height and/or width of the candidate object. In some embodiments, causing the radiation to be directed towards the candidate object comprises controlling the transmission apparatus to sweep a beam of radiation over the candidate object. The beam of radiation may have a diameter of between 10 and 50 centimetres.

In some embodiments the controller is housed within the detection apparatus. The controller may also be configured to be in communication with a web application, and controllable through an associated web-based client. Advantageously, a system configured as such may shift the burden of video processing away from a user device accessing the controller, allowing the system to be remotely controlled without the need for specialist hardware.

Previous systems, for example that disclosed in WO2009115818, rely on a step-wise sweep through the frequency range to determine features by accumulating data between discrete boundaries across the frequency range. This approach does not account for overlap in data clusters indicative of different threat types and effectively provides a pre-process filter. Data outliers caused by, for example, the human body itself will be incorporated into a particular bin, defined between adjacent boundaries, as a result of this step-wise sweep through the frequency range. These outliers can skew the data for that bin resulting in an erroneous classification. Conversely, a particularly significant spike in the data, indicative of a threat could be overlooked as a result of this truncation of the data. Furthermore, signal information for the same target could fall into a different bin and could result in a different classification.

The characteristics of the object may include one or more of the surface contours, the surface texture, the dielectric texture and/or the 3-dimensional shape of the object from which the transmitted radiation has been reflected. This approach enables the system to identify fragmentation devices in addition to single item weapons such as handguns and the like. In addition, this approach allows dielectric and other non-metal objects to be detected, aiding the identification of explosives.

The system may be mounted for attachment to a suitable substrate. The substrate may be any immovable item with sufficient strength to support the system. For example, the substrate may be a wall, door jamb, ledge or other piece of street furniture or building architecture that gives the system the desired range of view of the location to be surveyed.

The mount may be configured to enable the system to pan and/or tilt relative to the substrate on which it is mounted. This movement of the system relative to the substrate on which it is mounted enables the system to increase its overall field of view in comparison with a system on a static mount.

The controller may be operable to determine one of more characteristics of the object using a clustering algorithm. A clustering algorithm is well suited to this application because it is possible to determine that non-threatening items and distinct variants of threat items will produce marked differences in the signal features.

The controller may be operable to determine one of more characteristics of the object, through a preliminary step of filtering to eliminate spikes from the transformed signals. Spikes in the transformed signals may arise from the human body itself and may cause downstream data processing to be less effective. It is therefore advantageous to remove these from the raw data before any processing of the data occurs.

The controller may be operable to perform a least mean squares fit on the transformed signals subsequent to the preliminary step of filtering to eliminate spikes from the transformed signals.

The controller may be operable to determine one or more characteristics of an object upon which the transmitted radiation is incident by curve fitting to an n^{th} order polynomial and n may be 3 or greater than 3. In some embodiments, n is less than 11. In order to improve the fitting of the data, more than one representation of the curve may be prepared using a different polynomial. For example, the 3^{rd} and 8^{th} order polynomials may be deployed with the 3^{rd} order corresponding to the lower resolution and the 8^{th} order polynomial addressing the higher definition.

A weighting may be applied to at least one co-efficient of a polynomial. This may enable the system to deal with cluster overlap. It allows the system to normalise the distribution of a co-efficient and thereby to remove the correlation between each of the coefficients.

The system may further include a memory in which a plurality of classifiers indicative of different object characteristics are stored.

The invention will now be further and more particularly described, by way of example only, and with reference to the accompanying drawings, in which:

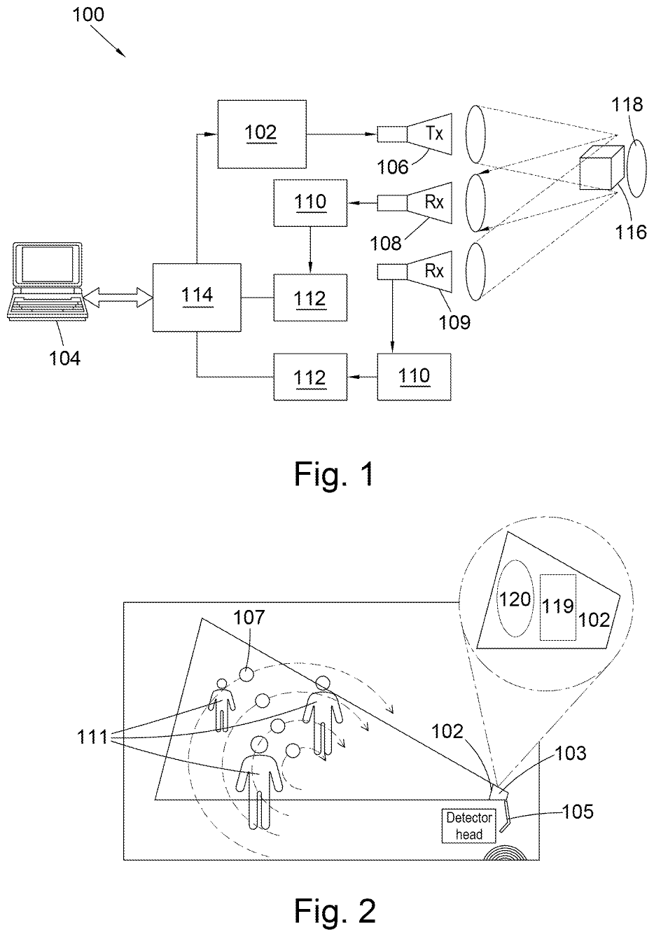

FIG. 1 is a block diagram of an object detection system capable of operating in accordance with some aspects of the invention;

FIG. 2 shows an example of a gimbal mounted object detection system in accordance with an embodiment of the present invention;

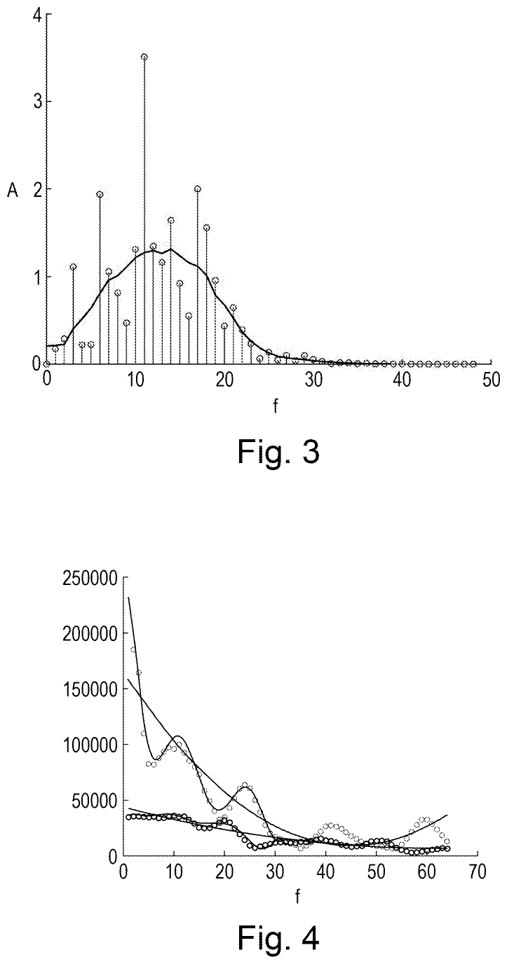

FIG. 3 shows an idealised trace representative of data received in accordance with some aspects of the invention;

FIG. 4 shows a real data set that has been smoothed and fitted against n^{th} order polynomial data;

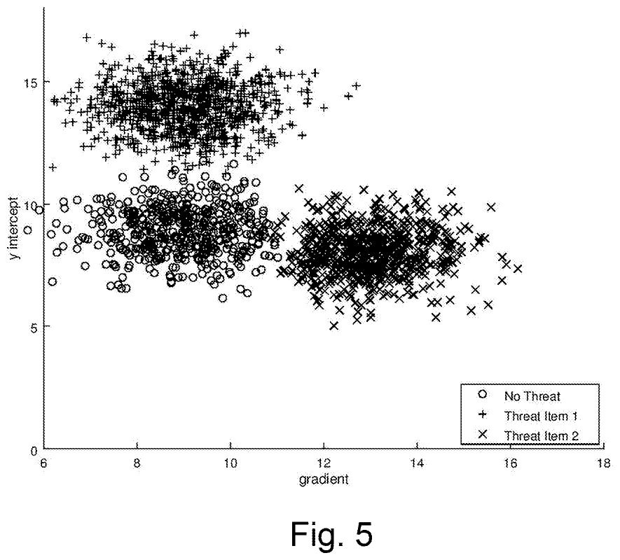

FIG. 5 shows polynomial coefficients plotted in a 2D space including clusters indicative of three different threat or non-threat classifications; and

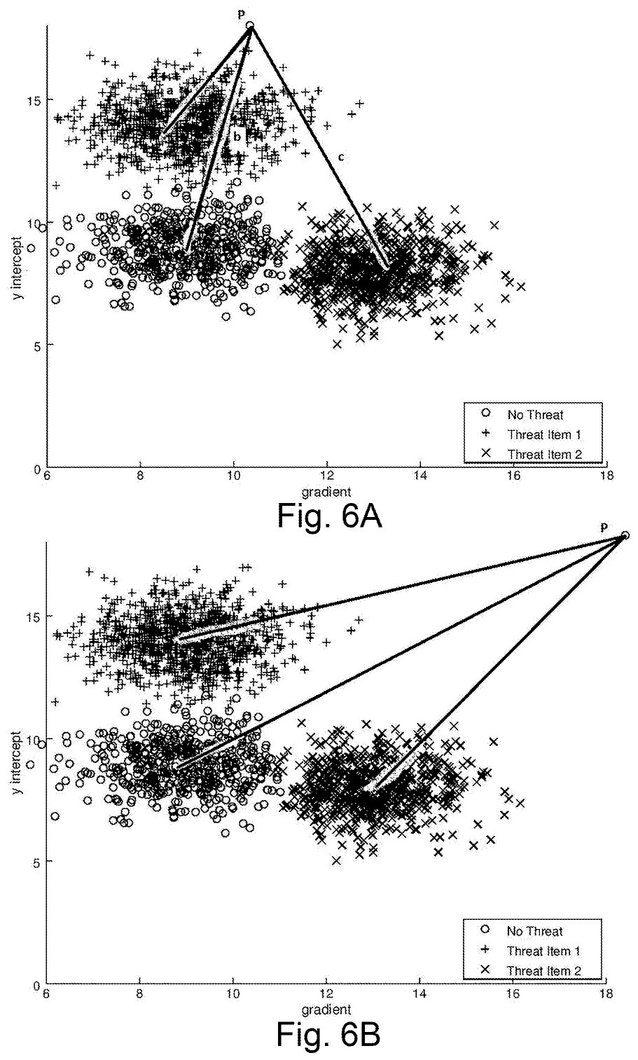

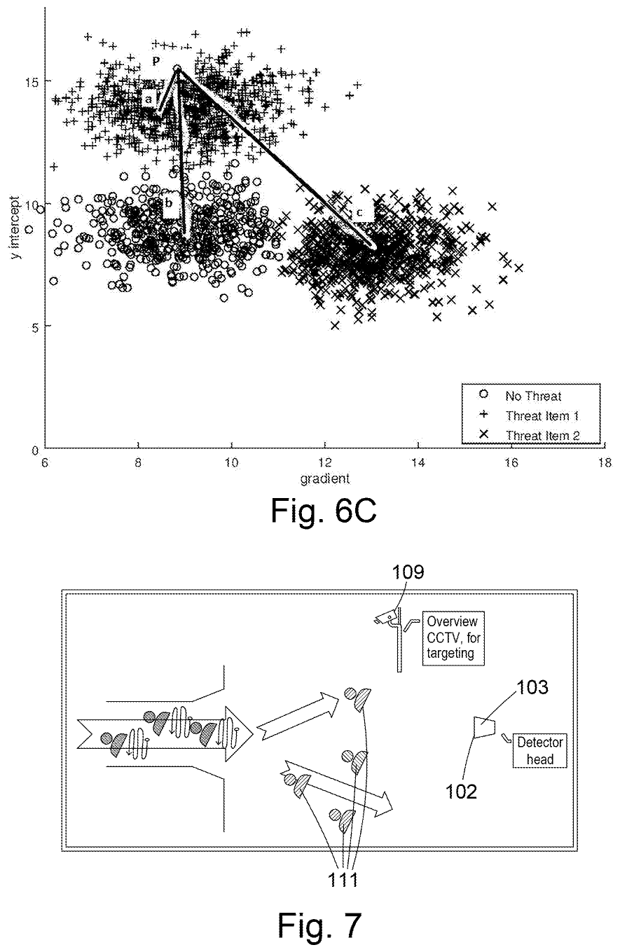

FIGS. 6A to 6C shows a data point P introduced into the 2D space of FIG. 4 to determine the classification outcome;

FIG. 7 shows an example of an object detection system operating in conjunction with a sensor component according to some aspects of the present invention;

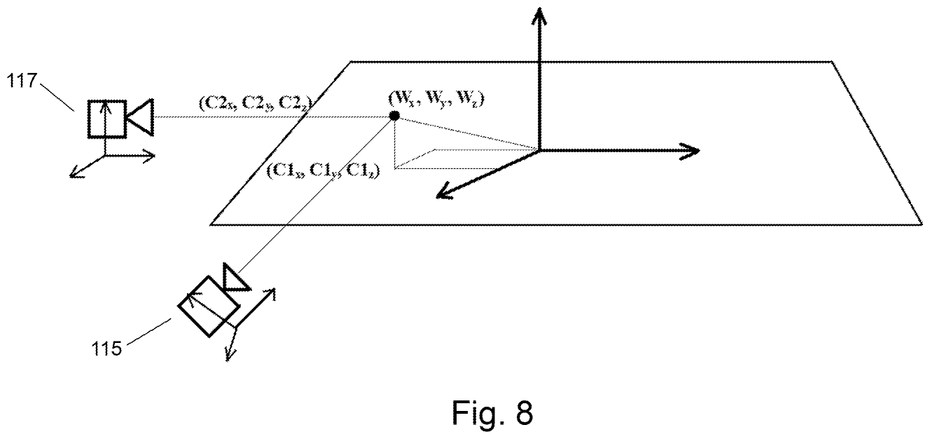

FIG. 8 shows an example sensor component configuration for estimating a position of an individual in a region of interest.

Various further aspects and embodiments of the present invention will be apparent to those skilled in the art in view of the present disclosure.

### DETAILED DESCRIPTION OF THE EMBODIMENTS

Embodiments of the present invention now will be described more fully hereinafter with reference to the accompanying drawings, in which embodiments of the Invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

If will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element such as a layer, region or substrate is referred to as being “on” or extending “onto” another element, it can be directly on or extend directly onto the other element or intervening elements may also be present. In contrast, when an element is referred to as being “directly on” or extending “directly onto” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Relative terms such as “below” or “above” or “upper” or “lower” or “horizontal” or “vertical” may be used herein to describe a relationship of one element, layer or region to another element, layer or region as illustrated in the figures. It will be understood that these terms are intended to encompass different orientations of the device in addition to the orientation depicted in the figures.

The terminology used herein is for the purpose of describing particular embodiments only and is not intended to be limiting of the invention. As used herein, the singular forms “a”, “an” and “the” are intended to include the plural forms as well, unless the context clearly indicates otherwise, it will be further understood that the terms “comprises” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs, it will be further understood that terms used herein should be interpreted as having a meaning that is consistent with their meaning in the context of this specification and the relevant art and wilt not be interpreted in an idealized or overly formal sense unless expressly so defined herein.

As used herein, “threat object” is taken to mean a metallic or dielectric object, whether specifically designed or intended for offensive use or not, that have potential to be used in an offensive or violent manner. It is intended to include fragmentation weapons which may comprise a plurality of individual parts severally located, rather than presenting as a single object.

The present invention is described below with reference to flowchart illustrations and/or block diagrams of methods, systems and computer program products according to embodiments of the invention. It will be understood that some blocks of the flowchart illustrations and/or block diagrams, and combinations of some blocks in the flowchart illustrations and/or block diagrams, can be implemented by computer program instructions. These computer program instructions may be stored or implemented in a microcontroller, microprocessor, digital signal processor (DSP), field programmable gate array (FPGA), a state machine, programmable logic controller (PLC) or other processing circuit, general purpose computer, special purpose computer, or other programmable data processing apparatus such as to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block, or blocks. It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Embodiments of the invention may be used for remotely detecting the presence and/or size of metal and/or dielectric objects concealed underneath clothing. Embodiments herein may be used for remotely detecting metal and/or dielectric objects. A dielectric in this context is a non-conducting (i.e. insulating) substance such as ceramic that has a low enough permittivity to allow microwaves to pass through. A ceramic knife or gun, or a block of plastic explosive, are examples of this type of material.

Some embodiments of detection systems are disclosed herein. FIG. 1 includes embodiments using direct detection without, phase detection. In some embodiments, the hardware may be embodied in a portable and covertly deployable system.

FIG. 1 is a block diagram of a threat object detection system 100. For the direct detection (without the phase) responses, the detection system 100 includes a microwave and/or mm wave source 102 (40 GHz Agilent Microwave Synthesiser). The system comprises a microwave and/or mm wave source 102, a detection system including a controller (PC) 104, three 20 dB standard gain horns used as a transmitter 106 and first and second receivers 108, 109 for the Ku and Q bands, a zero-bias direct detector 110 followed by an amplifier 112, and a high speed data acquisition card (PCI-6132 National Instrument interface) 114. The first 108 and second 109 receivers are configured to receive co-polarised and cross-polarised signals respectively. The amplifier 112 may be a DC amplifier or an AC amplifier. In some embodiments, the system may be controlled using control software including Labview or C# code, among others.

In use and operation, the system 100 uses electromagnetic radiation in the microwave or millimeter (mm) wave band, where the wavelength is comparable or shorter than the size of the object 116 to be detected. The object 116 may be on and/or in the body of a person, within containers and/or items of luggage, and/or concealed in and/or on some other entity (not shown). The suspect entity (e.g., a person; not shown) has radiation directed by transmitter 106 onto it, so that the (threat) object 116 is entirely illuminated by a continuous wave of this radiation (i.e., the radiation is not pulsed, but kept continuously on). The radiation intensity is well within safe operating limits, but may be in any case determined by the sensitivity of the detector 110. As an example, in the range 14-40 GHz, 0 dBm of power is used with a typical beam area 118 of 0.125 m² which equates to a 20 cm diameter beam. However, in some embodiments, the hardware may be designed so as generate a beam area 118 of greater or lesser size.

The frequency and consequently the wavelength of the radiation, is swept through a reasonable range and may be referred to as swept CW and/or continuous wave radiation. Limits may be set by the devices used or regulations in the location of use, but include, for example a 5 GHz sweep starting at 75 GHz; a 20 GHz or more sweep starting at 14, 50 or 75 GHz; and a 35 GHz sweep starting at 75 GHz. The data is as a real-time continuous sweep. Typically 256 or more data points may be acquired. In some embodiments, data may be taken between 14 to 40 GHz, providing a sweep range of 26 GHz.

The illumination and detection may be undertaken remotely from the object 116 in question, for example, at a distance of a meter or more, although there is no lower or upper limit on this distance. The upper limit on detection distance may be set by the millimeter or microwave focussing optics, although, with this technique, a small beam at the diffraction limit is not necessary. The effective range of the system 100 includes a few tens of centimeters (cm) to many tens of meters (m). In some embodiments, a device may be operated at a range of approximately 1 m to 10 m depending on the frequency chosen. Some microwave frequencies are attenuated by the atmosphere, and atmospheric windows such as that found around 94 GHz are generally chosen to minimise these effects. In some embodiments, the source of electromagnetic radiation 102 and the detector 110 may be mounted next to each other and they may be focussed onto some distant object 116 or entity (not shown).

The microwave and/or mm wave source 102; the transmitter 106; the first 108 and second 109 receivers, the two detectors 110, the two amplifiers 112 and the high speed data acquisition card 114 are all located within a housing (not shown). The housing is attached to a suitable substrate using a mount (not shown). The mount enables the housing as a whole to pan and tilt. Alternatively, the mount may be configured to provide only pan or only tilt movement depending on the location of the substrate to which the housing is mounted. The substrate may be a wall, roof or other piece of street furniture or internal architecture and it is chosen to give the transmitter 106 optimum coverage of the area to be surveyed.

Alternatively, as shown in the example of FIG. 2, the housing 103 can be mounted on a gimbal 105 for faster, smoother rotational scanning. An example operational setting for a gimbal mounted pointing system is to cause the threat object detection system to scan the microwave and/or mm wave radiation source 102 over 4 m wide circular paths 107 within the location of interest to screen candidate objects 111. A mounting configured as such is capable of scanning all un-occluded threats in a range of 10 to 30 m in under 1 second.

FIG. 2 further illustrates an example configuration within the housing 103 of the detector where a rotatable mirror 119 is placed between the microwave and/or mm wave radiation source 102 and a focusing lens 120. Such a configuration may allow for rapid scanning of the radiation beam via controlled deflection using the rotatable mirror. This rapid scanning may be done without movement of the actual detector head, effectively providing the detector head with a wider field of view.

The high speed data acquisition card 114 acquires the data from the amplifiers 112 and then sends this to the 104 for processing. The link between the card 114 and the 104 is achieved via any suitable local area network, including, but not limited to Wi-Fi.

In some embodiments, the controller 104 comprises an embedded computer such as a microcontroller, the microcontroller being co-located with the detection apparatus in the housing. In such embodiments, the microcontroller can be configured for wireless, two-way communication with a processor external to the housing to enable remote control of the detection apparatus.

An external processor may enable a user to access and control the detection apparatus via a web-based interface, thus shifting the burden of processing to the detection apparatus, and allowing users operating the threat object detection security system to do so via non-specialist hardware devices such as, for example, a low specification phone, tablet, or laptop with access to the internet.

FIG. 3 shows a computer generated idealised data set of a Fast Fourier Transform (FFT) of received data. The plot illustrates amplitude A against frequency f. The trace shows a typical response of the system to reflecting the transmitted beam off a human body. As will be apparent from FIG. 3, the data broadly follows the form of a Rayleigh distribution with a small number of conspicuous outliers. These are the outliers that are believed to arise from the human body itself and which are removed in a preliminary filtering step prior to the further processing of the data to determine the presence or absence and type of threat. When the outliers identified in FIG. 3 have been removed, the remaining data is further processed.

A real data set that has been subject to smoothing is shown in FIG. 4. This illustrates arbitrary units on the y-axis against frequency f on the x-axis. The 3^{rd} and 8^{th} order polynomial coefficients illustrated as solid lines in FIG. 4 appear to adequately describe the scattered response. The accuracy with which the polynomial represents the data will depend on the correct choice of polynomial.

The polynomial coefficients are plotted in an n^{th} degree space. FIG. 5 shows an example of a 2D space. A training data set is used to map out clusters indicative of the presence or absence of a threat item and, more particularly, the type of threat item. These are plotted in a space indicated by the Y-intercept (y-axis) against the gradient on the x-axis. O indicates data points obtained in circumstances where there was no threat. + and X indicate different types of threat item, summarised here as threat items 1 and 2 respectively.

The variance within the training data set will convert into a level of certainty in the classification. If there is too much data from varied sources this will result in a more aggressive overlap between clusters which may, in turn, make classification more challenging. In circumstances where the clusters are not well-defined, it may be possible to combine several classifications in order to identify the probability of the presence of a threat item.

The data shown in FIG. 4 is then subjected to a clustering vector analysis to produce a single point P which is located in the space illustrated in FIG. 5 and the location of point P is then used to determine the classification outcome. Three examples of the output of the clustering vector analysis are shown in FIGS. 6A-6C. In each case, the probability of a given threat or non-threat status of the data point P may be determined by comparing the Euclidean distances a, b and c, which are the distances from the point, P to the mean position of each cluster, or the cluster centre, although alternative mathematical methods may be deployed. The magnitude of the distances is related to the certainty with which a threat classification can be given. For example, in FIG. 6C, the distance a is very short and therefore there is a strong probability that threat item 1 is present. In FIGS. 6A and 6B, all of the distances, a, b and c are relatively long, so the prognosis is less clear cut than in FIG. 6C. However, distance a is notably shorter than distances b and c in FIG. 6A and therefore it is reasonable to conclude the FIG. 6A also relates to threat item 1, although this is less clear cut than FIG. 6C. FIG. 6B shows another data point P that has quite long distances a, b and c. The distances a and c are very similar and are less than distance b. From this the conclusion can be drawn that a threat item is present, but it is not abundantly clear whether it is Threat item 1 or Threat item 2. Although three classifiers are illustrated in FIG. 6, it will be understood that several classifiers could be used to determine the overall classification. Some of the classifiers may be indicative of the body type of the subject.

In some embodiments, weightings of the coefficients can be introduced in order to scale the data so as to normalise it. This may be useful where there is considerable overlap in clusters which prevents a clear classification to be made.

In some embodiments, hardware corresponding to the systems herein may form and/or be part of a portable device (i.e. small enough to be carried by one person, or transported in an automobile, so as to be operable therein).

Referring to FIG. 7, the above described threat object detection system of the present invention is further configured to operate in coordination with a sensor component 109 for identifying candidate individuals 111 to be scanned for threat objects by the microwave/mm radiation source 102 of the threat object detection system.

The term “sensor component” as defined herein refers to any sensor or set of sensors capable of providing information about a location of interest. For example, the sensor component may comprise one or more video cameras, thermal imaging sensors, passive SONAR detectors, or LIDAR detectors.

If the sensor component comprises multiple types of sensors providing information about a location of interest, the system of the present invention may comprise a sensor fusion module interfacing with the sensors and configured to aggregate the different types of information to reconstruct a three dimensional scene of the location of interest. In some embodiments, the sensor fusion module also processes the aggregated sensor data to identify which candidate objects 111 are potential threats and should be screened by the microwave radiation source.

In other embodiments, the sensors themselves are equipped with low level processing capabilities, and are configured to identify candidate objects and decide which candidate objects should be screened. In yet other embodiments both the identification of the candidate objects and the threat classification steps are performed by a server or a central processing unit.

In some embodiments, the sensor component comprises one or more video cameras configured to identify a number of candidate objects of interest within a field of view of the one or more cameras, and to communicate with the controller of the threat object detection system to direct radiation towards identified candidate objects. In some embodiments, the sensor component may comprise a plurality of video cameras or even an entire surveillance camera network with which the threat object detection system of the present invention can be integrated.

Referring to FIG. 8, an example embodiment of the present invention where the threat object detection system is operated in conjunction with two or more video cameras is illustrated.

Specifically, FIG. 8 illustrates two cameras 115 and 117 with overlapping fields of view, with local coordinate systems C1 and C2, directed at a point in a reference coordinate system known as the World Coordinate System. In the World coordinate system, this point is Wx, Wy, Wz, but when measured with respect to the camera 115, this point is represented by C1x, C1y, C1z, and by C2z, C1y, C2z with respect to camera 117. With the unit vectors of each coordinate frame known, it is possible to convert between each frame of reference using a transformation matrix. A three dimensional position estimate of the point with respect to the cameras can thus be made by combining the information from both cameras.

A square “checkerboard” pattern is used as a known target to calibrate the initial parameters of the cameras 115 and 117, enabling parameters such as position and orientation of the cameras with respect to each other to be determined. This computer vision technique is also used to generate the matrices of the cameras, which include other relevant parameters such as lens distortion, pitch, roll, yaw. Once these factors have been determined, the cameras are able to generate three dimensional positional estimates for candidate objects that enter their field of view.

The information from each camera is combined to produce a robust tracking solution. The location of the candidate objects, for example pedestrians and unattended bags, are determined and represented by bounding boxes in a three dimensional pixel coordinate system. In some embodiments, this bounding box is sent to a higher level component in the software architecture for inclusion in a video overlay. The information is also used to calculate changes in the orientation of the cameras, for example changes in the pan and tilt or rotation of the cameras caused by the cameras tracking an object of interest.

In some embodiments where the sensor component comprises multiple video cameras 115 and 117, the method of implementing the above described threat detection comprises three stages.

In a first stage, a candidate object is detected and identified in a video feed, optionally being assigned a unique ID by a processor, and their position, and optionally their size dimensions, is/are defined relative to the video camera.

Software components are connected to each individual camera, and to the other sensor components if there are any, and extract metrics from each camera image and each other sensed parameter. These metrics are used to create a model of the sensed scene in 3D. Metrics might include object detection or feature point recognition. This module may also calculate estimates of the spatial location in 3D space. In some embodiments, one instance of this software component runs for each camera or other sensor, and the execution of this process may occur either locally or remotely to the sensor(s).

Various methods of metric extraction are available including background subtraction in the case of fixed cameras and object detection algorithms using deep neural networks.

In some embodiments, each set of metrics are sent from the cameras on a frame by frame basis, and require synchronisation using methods that may include meta-data time stamps. The system can thus compensate for varying factors between cameras, including differences in latency and frame rate.

This first stage could further comprise performing object classification on the candidate objects, once identified, to determine if they are a person or an item, such as for example a suitcase. The first stage could also further comprise the step of, if the candidate object is determined to be a person, performing facial recognition and even behavioural analysis on that person and comparing determined attributes to a database of known individuals of interest. Such video analysis can be performed by deep learning algorithms and neural networks.

Features such as image segmentation of the candidate object, along with pose estimation may also be employed to provide the classification algorithms with contextual awareness. The purpose of this being to augment information regarding the body context of the radar beam to amend the threat classification appropriately. If the radar beam is directed at an area of the candidate known to produce a challenging environment for a given classification library, for example belts and zips are known to risk producing false positives in some classification libraries, the algorithm may instead switch to a more appropriate classification library.

In a second stage, the position of the identified candidate object/person is used in a coordinate transform as described above to calculate the change in pointing direction of the threat object detection apparatus required to direct radiation towards the candidate object/person. For example, a pan/tilt/zoom for the system may be determined. Alternatively, a rotation of a gimbal-mounted system may be calculated.

In a third stage, the identified candidate object/person may be scanned partially or completely by the threat object detection system in order to classify the candidate object as a threat or a non-threat. This may comprise, for example, oscillating or “nodding” the pointing direction of the radiation emitted by the threat object detection system back and forth over the candidate object/person to wholly or partially scan them and determine whether the candidate object is an object of interest. This is illustrated in FIG. 7. Partially scanning a candidate object may, for example, comprise scanning a portion of a person that has been determined to potentially be concealing a threat object.

In some embodiments, reinforcement learning algorithms may be employed by the controller to, rather than causing the radiation to be directed over objects using a simple nodding movement, use a scanning pattern based on the perceived shape of the candidate object to ensure the entire profile of the candidate object is screened prior to threat evaluation. Such optimised scanning procedures ensure that individuals and items are not marked as non-threats if parts of their profile have not yet been scanned for concealed threat objects.

In other embodiments, scanning may comprise adjusting the direction of the radiation beam using the rotatable mirror 119 described above in relation to FIG. 2. The rapid scanning and fine adjustment of the beam direction enabled by the rotatable mirror 119 is particularly advantageous for scanning groups of candidate object that are clustered together, as the whole group may fall within the expanded field of view of the detector. For example, the detector may be able to screen an entire group of candidate individuals for threat objects without actually moving the detector head.

Furthermore, unlike conventional wide beamwidth detectors, which may also be able to rapidly scan clusters of candidate objects, the approach of the present disclosure of assigning a unique ID to each identified object and associating threat/non-threat classifications with those objects once screened enables candidate objects of interest from within the cluster to be resolved and tracked even if the cluster disperses. For example, a person of interest may be identified in a crowd and followed subsequent to parting with the crowd.

In some embodiments, if the candidate object is determined to be a threat or an object of interest, the system may further be configured to use the unique ID assigned to the object during the identification stage to track and monitor the object of interest using the sensor component, while at the same time continuing to identify and scan new candidate objects as described above.

Metrics representing candidate object positions are determined for each camera. With sufficient cameras present to cover all reasonable viewpoints (which may include directly above), it is possible to augment these data to overcome problems with occlusions, missing detections, false detections (which may appear from one viewpoint, but not from others) and other limitations.

Furthermore, to account for the possibility of missed detections in frames in the tracking method, caused either by occlusion or by another algorithm limitation, the use of an Extended Kalman Filter, a particle filter, or other machine learning based tracking filter may be helpful, especially since it is unlikely that the physical environment in which the system is deployed will permit comprehensive, un-occluded oversight of the scene. Such techniques allow for candidate objects to continue to be tracked in the absence of sensed data, and may take place for each camera, and/or may also take place at the higher level within the 3D reconstruction.

In some embodiments, if a candidate object is determined not to be a threat, that object may have a non-threat classification associated with their unique ID to avoid screening the same object twice, at this point the system may cease to track them.

Although example tracking policies are described herein, it will be appreciated that the threat detection system of the present invention is configurable, and in particular that the tracking policy of the system may be configured to track or not track objects according to user requirements.

In some embodiments, the integration of the sensor component and the threat object detection system enables autonomous identification and scanning candidate objects and subsequent autonomous tracking of those objects determined to be objects of interest.

In some embodiments, the sensor component may be housed in a nearby but different location to the threat object detection system. Beneficially, such a configuration may enable occlusions of target objects to be resolved, by having the candidate object always in view of at least one of the sensor component and the threat object detection apparatus.

It will further be appreciated by those skilled in the art that although the invention has been described by way of example with reference to several embodiments. It is not limited to the disclosed embodiments and that alternative embodiments could be constructed without departing from the scope of the invention as defined in the appended claims.

1. A system for remote detection of one or more dimensions of a metallic and/or dielectric object, comprising:
at least one sensor component configured to identify one or more candidate objects,
a transmission apparatus, including a transmission element, configured to direct microwave and/or mm wave radiation,
a detection apparatus configured to receive radiation from an entity resulting from the transmitted radiation and to generate one or more detection signals in the frequency domain, and
a controller, the controller being operable to:
(i) generate location data for the one or more candidate objects based on data received from the sensor component;
(ii) cause the transmission apparatus to direct radiation towards a candidate object ,
(iii) cause the transmitted radiation to be continuously swept over a predetermined range of frequencies,
(iv) perform a transform operation on the detection signal(s) to generate one or more transformed signals, and
(v) determine, from one or more features of the transformed signal, one or more characteristics of the candidate object upon which the transmitted radiation is incident.

2. The system according to claim 1, wherein the system is further configured to determine, based on the characteristics, that the candidate object is an object of interest.

3. The system according to claim 2, wherein upon determining that the candidate object is an object of interest, the system is configured to track the candidate object using the at least one sensor.

4. The system according to any preceding claim, wherein the at least one sensor component comprises a video sensor.

5. The system according to claim 4, wherein generating location data comprises generating an estimated position of the candidate object within a model of the scene viewed by the video sensor.

6. The system according to any of claim 4 or 5, wherein the controller is further configured to determine a height and/or width of the candidate object.

7. The system according to any preceding claim, wherein the controller is housed within the detection apparatus.

8. The system according to any preceding claim, wherein the controller is configured to be in communication with a web application, and controllable through an associated web-based client.

9. The system according to any preceding claim, wherein identifying and determining the characteristics of the candidate objects is performed autonomously.

10. The system according to any preceding claim, wherein causing the radiation to be directed towards the candidate object comprises controlling the transmission apparatus to sweep a beam of radiation over the candidate object.

11. The system according to claim 10, wherein the beam of radiation has a diameter of between 10 and 50 centimetres.

12. The system according to any preceding claim, wherein the characteristics of the object include one or more of the surface contours, the surface texture, the dielectric texture and/or the 3-dimensional shape of the candidate object.

13. The system according to any preceding claim, wherein the controller is operable to determine one of more characteristics of the object using a clustering algorithm.

14. The system according to any preceding claim, wherein the controller is operable to determine one of more characteristics of the object, through a preliminary step of filtering to eliminate spikes from the transformed signals.

15. The system according to claim 14, wherein the controller is operable to perform a least mean squares fit on the transformed signals subsequent to the preliminary step of filtering to eliminate spikes from the transformed signals.

16. The system according to any preceding claim, wherein the controller is operable to determine one or more characteristics of an object upon which the transmitted radiation is incident by curve fitting to an n^{th} order polynomial.

17. The system according to claim 16, wherein more than one representation of the curve is prepared using a different polynomial.

18. The system according to claim 17, wherein the polynomials are 3^{rd} and 8^{th} order polynomials.

19. The system according to any of claims 16 to 18, wherein a weighting is applied to at least one co-efficient of a polynomial.

20. The system according to any preceding claim, wherein the system includes a memory in which a plurality of classifiers indicative of different object characteristics are stored.
